(19) United States
(12) Patent Application Publication
(10) Pub. No.: US 2009/0276250 A1
(43) Pub. Date: Nov. 5, 2009

(54) PROCESS AND SYSTEM TO DETERMINE COMMERCIAL AIRLINE ARRIVALS

(75) Inventors: John C. KING, Peachtree City, GA (US); William M. Burnette, Palmetto, GA (US); Christopher G. Burger, Peachtree City, GA (US); Darren R. Heil, Peachtree City, GA (US); Steven C. Kiroff, Toronto (CA); Geoffrey A. Wolfe, Alexandria, VA (US)

Correspondence Address: MCGUIREWOODS, LLP, 1750 TYSONS BLVD, SUITE 1800, MCLEAN, VA, 22102, US

(73) Assignee: Travel Tech Systems, LLC, Peachtree City, GA (US)

(21) Appl. No.: 12/432,545

(22) Filed: Apr. 29, 2009

Related U.S. Application Data
(60) Provisional application No. 61/049,691, filed on May 1, 2008.
(60) Provisional application No. 61/111,108, filed on Nov. 4, 2008.

(51) Int. Cl. G06Q 99/00; G06F 15/16; G06F 17/30; G06Q 10/00; G06Q 50/00; G06N 5/02

(52) U.S. Cl. 705/5; 709/206; 707/3; 706/52; 707/E17.014

(57) ABSTRACT

An apparatus, a method, a system and a computer program for providing users with early and accurate information relating to a status of a particular flight. Early and accurate information relating to a status of a particular flight is provided to the user. The method includes receiving user data that includes aircraft departure information, determining inbound aircraft data based on the user data, receiving constraint status information, generating update status data based on the inbound aircraft data, outbound aircraft data and constraint status information, and sending an update status message to the user.

### CROSS REFERENCE TO PRIOR APPLICATIONS

This application claims priority and the benefit thereof under 35 U.S.C. §119(e) from U.S. Provisional Application No. 61/049,691, filed on May 1, 2008, and U.S. Provisional Application No. 61/111,108, filed Nov. 4, 2008, both of which are hereby incorporated by reference for all purposes as if fully set forth herein.

### FIELD OF THE INVENTION

The present invention provides an apparatus, a method, a system and a computer program for providing users with early and accurate information relating to a status of a particular trip, aircraft, vehicle, or person, as well as information relating to available alternative arrangements. More particularly, the invention relates to an apparatus, a method, a system and a computer program for providing users with early and accurate information relating to a status of a particular flight.

### BACKGROUND INFORMATION

Although a particular itinerary may be planned weeks ahead of a planned trip, travel arrangements may be changed at the last moment. Many times travel service providers (such as, e.g., airlines, travel agents, flight information providers, or the like) inform travelers of delays or cancellations only a few hours ahead of the departure time. Often this does not allow a traveler time to study alternatives and to then change travel arrangements to a more suitable schedule.

FIG. 1 shows a map of the United States of America. Referring to FIG. 1, a traveler may plan an itinerary, including a flight from John F. Kennedy International airport (JFK) in New York to Los Angeles International airport (LAX) in California with a flight transfer at Denver International airport (DEN) in Colorado. The traveler may make further arrangements to pick up a rental car upon the scheduled arrival time at LAX. Accordingly, if the scheduled flight from New York is delayed or canceled due to, for example, inclement weather, the traveler may have difficulty in arranging another flight to DEN airport to make the scheduled transfer flight from DEN airport to LAX airport. The delay or cancellation may become much more pronounced when dealing with scheduled flights to or from locations which may have only a single flight scheduled per day, or less frequently.

### SUMMARY OF THE INVENTION

An apparatus, a method, a system and a computer program are provided for accurately informing users (such as, e.g., travelers) of potential delays or cancellations earlier than the notification provided by transportation providers (such as, e.g., airlines, flight information service providers, etc.); extending the value of that early warning with information and methods to enable the most efficient change to their travel plans which is made possible due, for example, to the early nature of the information. The apparatus, method, system or the computer program communicate with the user through communications including, but not limited to, those enabled by internet document protocols, internet mail protocols, internet news feed protocols, phone and cell phone short message protocols. This may be realized as a web page, client application, email, VRU, SMS or other mobile devices based on the traveler's preferences.

According to an embodiment of the invention, an apparatus, a method, a system and a computer program are provided for discovering, in realtime, one or more flight segments of an aircraft that will ultimately be the aircraft that will provide service for the users flight and are contiguous to each other and to the user's scheduled flight; discovering the available flight data for each of the identified segments of that aircraft; discovering the airports that those identified segments either originate or terminate in; optionally discovering available data describing the conditions at those airports; analyzing the combination of each of the identified segments using mathematical and decision tree analysis with other constraining factors to determine the impact on the traveler's flight departure; communicating this analysis to the traveler using various methods; and supporting the discovery and analysis on a user's connecting flights that make up a user's trip.

Further, an apparatus, a system and a method are provided for discovering an inbound aircraft that may be utilized for a user's outbound flight. The user provides or selects a unique identifier of the airline, the flight number, the airport of departure, and the date of departure of the flight to be analyzed either thru a registration web page, the parsing of an email or text message sent to the system or the programmatic processing of the user's emailed itinerary whether provided by the airline, travel agency or other sources. The system may determine the validity of the provided data by searching for it within the available flight data. Using the registered and validated flight's data, the system may retrieve data on flights from the same airline that are arriving at the traveler's departure airport on the departure date from FAA, airline and other sources. Search these flights for scheduled candidate flight that might supply the airplane for the traveler's departing flight. Narrow the candidates based on aircraft type, a variable window of time for the flight's scheduled arrival, tail number, assigned airport gate number, or ship number. Repeating the foregoing steps to find the flights of the same aircraft's planned routing on preceding segments, allows the monitoring the aircraft's progress.

Further, an apparatus, a system and a method are provided for determining and storing constraint factors and/or constraint data impacting flight performance. Constraints may be stored to optionally and dynamically adjust the factors that impact the on-time performance of the traveler's flight. Various constraints based on airports and or airlines may be entered by an observer, an expert or calculated automatically based on available data, both historic and realtime. These constraints may include but not be restricted to: airport closure times; historic airport or airline times to process an arriving airplane before it is ready to depart again; reported taxi times; times added by an airline because of expected delays; baseline city-pair flight times; historic weather effects on airport arrival or departure capacity; historic weather effects on city-pair flight times; airport congestion, ATC flow restrictions.

Further, an apparatus, a system and a method are provided for analyzing flight arrival and departure times utilizing aircraft routings and constraint values. Using the flight data from the discovery system or method for the inbound airplane, the system or method may analyze the inbound flight's data and applicable constraints by applying mathematical and decision tree analytic methodologies to determine if there is any impact on the traveler's flight departure or if the flight is likely to be cancelled. Depending on the result of the analysis of the scheduled flight, if the flight is cancelled or greatly delayed, search for other flights on the same or other airlines that cover both flights scheduled to depart before the target filing but were delayed and flights for some period of time after the target delayed or cancelled flight that gives the user alternative flight options. If the flight is delayed past the scheduled departure time, then additional notifications are dynamically added to continue monitoring and analyzing the status of the departure using the above methodologies.

Further, an apparatus, a system and a method are provided for notifying a user of flight analysis, comprising: provide the results of the flight analysis to the user's selected wired or wireless devices, wired computing device or phone, using but not limited to email, SMS (short message service) text messaging, VRU (voice response unit), text-to-speech, email with HTML and various graphical displays including, but not limited to, geospatial display showing upline and target aircraft location and flight data; and/or including additional alert messages. The system and/or method may further comprise: sending the user additional information and/or links that may assist in but not limited to booking other flights, hotels and rental cars; sending list of Alternate flights for the same or other airlines that cover both flights scheduled to depart before the target flight but were delayed and flights for some period of time after the target delayed or cancelled flight; determining if flight is “last flight of day” to the desired destination and is in a greatly delayed or cancelled status to provide specific messaging to user regarding lodging and/or alternative flights on the following day; using available data sources, provide lodging alternatives at the given location indicating those with available space when logic determines to send a lodging message; and/or sending information to the traveler when they have disrupted travel because of cancelled, substantially delayed flight or denied boarding. Analyze the type of disruption and location to determine what information to send. This could include but not be limited to Airline Bill of Rights sections that apply to the disruption, Airline Carriage contract rules that apply to the disruption, such as meal and hotel vouchers, airline dollars, and other compensations for which the traveler is entitled, and providing the user with a form or link to send complaints to the DOT because of problems with airline service.

The apparatus, system and/or method may further comprise: providing the user with an ability to add a human created message into a stream of notifications to deliver to an individual user, or to a group of users, information relevant to their travel but not provided by automated analysis. This information could include answers to a previously asked question, results of a concierge activity, general information of importance relative to the airline being flown or current air travel in general, or other items that may have impact on the travel to which the notifications apply. The system and/or method may further comprise providing the user with an ability to optionally include non-travel related information, but information desired by the recipient of the messages, within or via hyperlink from the notification. These might include weather in cities not on the current itinerary, news or stock quotes relating to the user to which this trip relates, or other items that would benefit the user from consolidation within the message.

Further, an apparatus, a system and a method are provided for informing a user when other users that are identified as friends or contacts are in the same location, comprising: associating other users as friends or contacts by importing contact lists from but not limited to Outlook, Yahoo, Google, Linkedin, Facebook, MySpace or other social networks; determining when a user's identified friends or contacts are traveling into or out of a common airport, city, or location within a defined period of time; using location based services from devices including but not limited to GPS phones, to provide additional and more specific location information; associating colleagues into different groups that then determine when location notification is provided; determining by trip and/or by contact whether their presence will be visible to other travelers; and/or notifying the user through a wired or wireless devices or PCs, using but not limited to email, SMS text messaging, VRU, email with HTML, and geospatial depictions of colleagues locations.

Further, an apparatus, a system and a method are provided for synchronization of user's travel itinerary with computer or mobile based calendars, comprising: registering certain flights to track from computer based calendars such as Outlook, Yahoo, Gmail, etc.; providing a copy of their email itinerary, then automatically update their designated calendars (e.g. Outlook, Yahoo, Gmail, etc).

Further, an apparatus, a system and a method are provided for discovering and supporting a user's connecting flights, comprising: creating a trip made up of multiple flights or discovering from a passenger's trip itinerary multiflight connections; applying the previously described systems and/or methods to determine the status of the connecting flight's departure and include this status in the applicable notifications of the parent flight segment; applying this analysis both to the individual flight's status and to the relationship to the connection flight segments; and notifying the user about the status of his flight connections using the previously described methods.

Further, an apparatus, a system and a method for alerting and/or storing alert messages and factors impacting flight performance, comprising: storing alerts to provide additional messages as part of the previously described flight performance notification to travelers as warnings of factors that may affect their flight's departure and/or arrival; providing alerts information related to airport and/or airlines that can be entered by an expert observer; providing alerts parameters that include but are not limited to the airport code, airline, additional delay time, start and end date and time period that alert will be effective, and the alert message text.

Further, an apparatus, a system and a method are provided for determining the inbound aircraft that may be utilized for a user's outbound flight, comprising: receiving a name of the airline, the flight number for the flight the user is interested in, the station code for the airport of departure for that flight number, and the date of operation of the flight; access the airline web site and/or other data sources to determine the type of aircraft that is operating that user's flight and the departure airport gate number that the user's flight will depart from; referencing the airline's schedule of arrivals at that same airport and select those inbound flights that utilize the same type of aircraft and that are scheduled to arrive within a window of time ahead of the user's departing flight; given this selection of flights, searching gate assignment data to determine which inbound flight matches the airline, aircraft type and gate assignment of the user's chosen outbound flight. If the airline, aircraft type and gate assignment match and if that flight is scheduled to arrive within the specified window of time ahead of the user's flight departure, then in most cases that indicates that the same aircraft will be used for the inbound and outbound flights. There are exceptions. Particularly with the smaller regional jets now being utilized for many flights, multiple aircraft can be assigned to the same airport gate for a given airline. This is particularly true in larger airports where several regional jets might park around the same gate area and generally at about the same time. In order to more accurately determine which inbound aircraft matches which outbound aircraft in this situation, maintain a history of flight performance for flights that utilize a common gate at a common time. Specifically, certain instances where a given inbound flight's late arrivals over time match an outbound flight's delayed departures may be referenced. If this pattern is consistent over several instances, then this may indicate that the same aircraft is in use for the inbound and outbound flights. Whenever airlines change overall schedules, then reassess this match of inbound to outbound flight performance to determine if aircraft tracking is still accurate. By using this approach the inbound flight may be determined that uses the same aircraft that may be used for the user's outbound flight. The foregoing described systems and/or methods may be used to determine additional aircraft routing information. By looking at the inbound flight number and the airline schedule, an airport may be determined from which the inbound flight is coming from and the departure gate assigned to that flight at that airport. By knowing the airline, the outbound flight number, its scheduled time of departure, its departure gate and the aircraft type, the inbound aircraft that may be used to fly a particular outbound flight may be determined. Further, a particular aircraft's planned routing through several airports on a particular day may be determined and tracked. Resultantly, real-time information may be determined for the aircraft that may fly the user's chosen flight, and the information may include status information for the aircraft at least one stop ahead and many times several stops ahead of the user's chosen flight.

Further, an apparatus, a system and a method are provided for determining and storing factors impacting flight performance, including constraint factors and/or a Table of Constraints, comprising: matching inbound aircraft to the outbound flight to be flown by that same aircraft; determining which aircraft may be utilized for the user's chosen flight to at least one airport prior to the user's airport of departure; tracking which aircraft may be used for the user's chosen flight several stops ahead of the user's flight if the user has asked for flight tracking to begin that far ahead of their departure flight; when the aircrafts routing has been determined, begin analyzing possible additional delays or opportunities to make up time as the aircraft flies from city to city along its route; determining constraints data such as, e.g., weather, congestion on the ground at airports, government flow capacity restrictions, and airline scheduled flight times vs. actual flight times; tracking possible impacts to an aircraft's flight times based on the constraints data, including creating a Table of Constraints in the system; assessing data concerning conditions at the major airports, including data available from public, airline and government sources as well as data consolidation services (such as, e.g., local weather data, Air Traffic Control (ATC) data, and flight delay and arrival/departure from airline web sites; gathering constraints data and storing the data into, e.g., the Table of Constraints, including timing information collected regarding both airline and/or airport impacts to an aircraft's performance against its schedule; entering airport data by, e.g., three letter station code and time limits are set for the period during within which we believe that data to be accurate. There are four types of data that may be used, including: Weather delay data; ATC flow control data; actual airport taxi delay; and airport hours of operation. Airline specific data may also be entered into the Table of Constraint, including turn time and schedule pad time.

Further, an apparatus, a system and a method are provided for projecting flight arrival/departure times utilizing aircraft routings and constraint table values, comprising: receiving user data including how far ahead of predetermined flight departure time a user wants to begin tracking their aircraft; determining the routing of the aircraft that may be used to fly the user's flight; determining which airports the aircraft will traverse and which flights it will fly as it moves through its scheduled routing; determining where the aircraft will be at the time tracking is to begin for a user; sending messages to the user at intervals and with the type of delivery requested by the user, including messages that tell the user where the aircraft is located, whether it is running ahead or behind schedule, any schedule impact that might be expected as it flies the flights and traverses the cities along its route, a summary of the information that the user's airline is providing as to their projections as to whether the flight will be on time, ahead of schedule, or delayed, or the like. Projecting flight times may comprise: determining where the aircraft is at the times where the user has asked for a status message; determining the flight number being flown by the aircraft at that moment; accessing an airline web site or a data consolidator's site and querying for current status of that flight; obtaining information regarding the airline's projected departure/arrival time vs. its scheduled departure/arrival time for that flight; storing the minutes ahead or behind schedule for use in the message to be sent to the user; using the data stored in the Table of Constraints to add (additional delay time) or subtract (time that might be made up) time in minutes based on the schedule pad time and turn time constraints for the airline for each segment flown and for each airport traversed by that aircraft until it is projected to reach our user's point of departure; at each airport that the aircraft will traverse, adding or subtracting the minutes of additional delay time or time that might be made up due to the four airport constraints (weather delay, ATC flow control delay, taxi delay, or hours of operation), which may be retrieved from the Table of Constraints; determining the resulting projected arrival and departure time at the user's airport by adding all of these impacts together; creating a message to the user that summarizes the projection along with the information currently being provided by the airline.

Additional features, advantages, and embodiments of the invention may be set forth or apparent from consideration of the following attached detailed description and drawings. Moreover, it is to be understood that both the foregoing summary of the invention and the following attached detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced.

FIG. 1 shows a map of the United States of America;

FIG. 2 shows an embodiment of a flight information (FI) system, according to the Invention;

FIG. 3 shows a process for determining and updating information regarding a particular flight arrival and/or departure, according to an embodiment of the invention;

FIG. 4A shows a process for determining inbound aircraft data, which may be used in the process shown in FIG. 3, according to an embodiment of the invention;

FIG. 4B shows a process for projecting flight arrival/departure times using aircraft routings and constraint data in the process shown in FIG. 3, according to an embodiment of the invention;

FIG. 5 shows a process for determining constraint status data, which may be used in the process shown in FIG. 3, according to an embodiment of the invention;

FIG. 6 shows a process for processing the received user data, the determined inbound aircraft data and the constraint status data to generate travel update status data and user notification data in the process shown in FIG. 3, according an embodiment of the invention; and

FIG. 7 shows a process for sending messages and user notification data to a user in the process shown in FIG. 3, according to an embodiment of the invention.

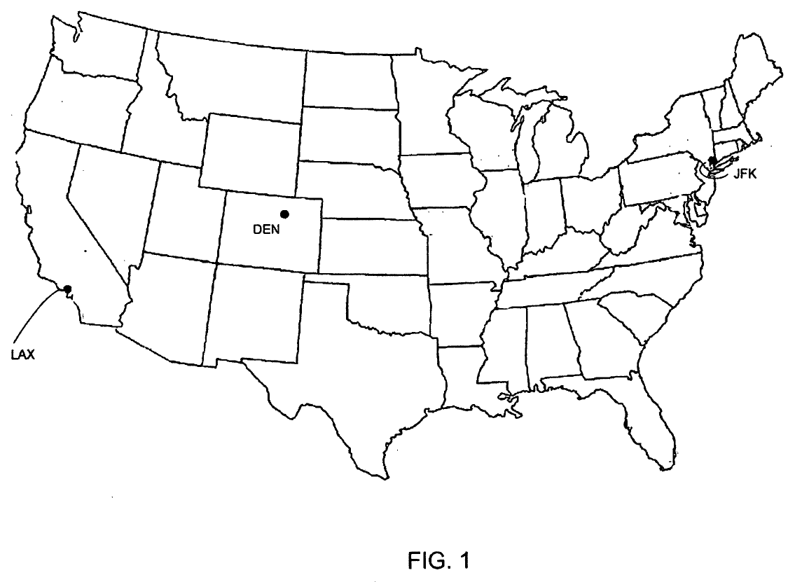

The present invention is further described in the detailed description that follows.

### DETAILED DESCRIPTION OF THE INVENTION

The embodiments of the invention and the various features and advantageous details thereof are explained more fully with reference to the nonlimiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention.

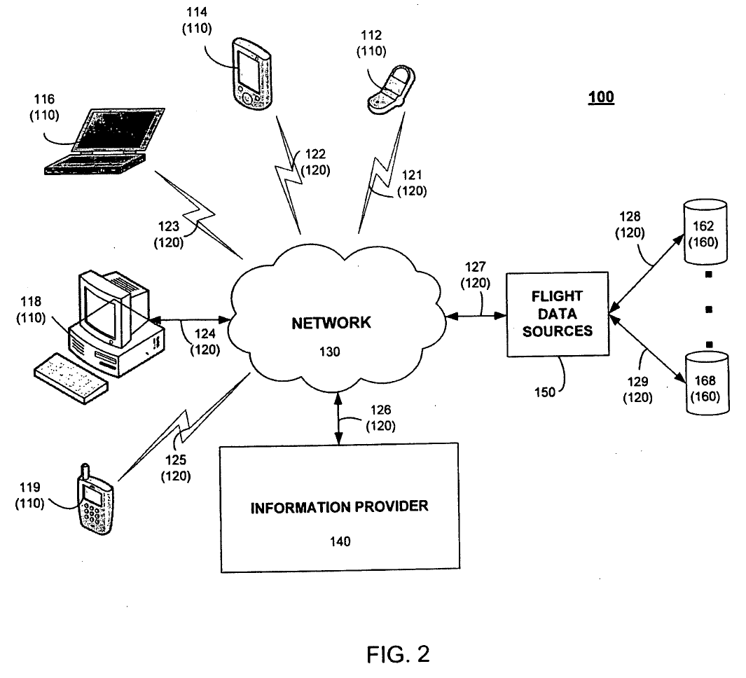

FIG. 2 shows an example of flight information (FI) system 100, according to an embodiment of the invention. The FI system 100 includes one or more user interface devices (UID) 110, one or more communication media 120, at least one network 130, an Information Provider 140, one or more flight data sources 150, and one or more databases 160.

Each of the UIDs 110 may include an electronic device configured to communicate over a communication media 120. The UIDs 110 may communicate with each other, the information provider 140 or the flight data sources 150 via the communication media 120 and/or the network 130. The UIDs 110 may include, for example, a mobile telephone 112, a personal data assistant (PDA) 114, a mobile computer 116, a stationary computer 118, a smart phone 119, or the like. The mobile computer 116 may include, but is not limited to, for example, an electronic device configured to accept data, perform prescribed mathematical and logical operations at high speed, and output the results of these operations. The mobile computer 116 may further include, for example, but is not limited to, a display, a voice response unit (VRU), a text-to-speech or speech-to-text application, an audio pickup device, a video pickup device, and the like.

The UIDs 110 may communicate data over the communication media 120, such as, for example, data enabled by internet document protocols, internet mail protocols, internet news feed protocols, phone and cell phone short message protocols. For example, communication amongst the UIDs 110, the network 130, the information provider 140, the flight data sources 150 and/or the databases 160 may be realized as a web page, client application, e-mail message, text message, instant message, broadcast message, audio message, video message, Short Message Service (SMS) text message, an HTML message, or any other known message type capable of facilitating communication of information between the UIDs 110, the network 130, the information provider 140, the flight data sources 150 and/or databases 160.

Data and information may be communicated using, for example, but not limited to any one or more of the following protocols, including: Real-time Transport Protocol (RTP); RTP Control Protocol (RTCP); Redirect RTCP; Remote Audio Output Protocol (RAOP); Secure RTP; Session Initiated Protocol (SIP); P25 ISSI Protocol; Internet Protocol (IP); Real Time Streaming Protocol (RTSP); RTP-MIDI Transport Protocol; Session Announcement Protocol (SAP); H. 323 Protocol; MP3; Lightweight Telephony Protocol; TCP/IP; HTTP; MMS Protocol; or the like.

The communication media 120 may include wired and/or wireless communication links, such as, for example, any one or more of: a satellite communication link, a cellular communication link, a radio frequency (RF) communication link, an Infrared (IR) communication link, an optical communication link, or the like, without limitation. The RF communication link may include, for example, WiFi, WiMAX, Bluetooth, or the like. As seen in FIG. 2, the communication media may include communication links 121, 122, 123, 124, 125, 126, 127, 128 and 129.

The network 130 may include, but is not limited to, for example, at least one of the Internet, a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

The information provider 140 may include one or more servers (not shown), which may include, for example, any combination of software and/or hardware, including at least one application and/or at least one computer to perform services for connected clients. The at least one server application may include, but is not limited to, for example, an application program that can accept connections to service requests from clients by sending back responses to the clients. The server (not shown) may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

The flight data sources 150 may include, for example, any one or more of an aircraft, an airline provider, an airport, a government agency (such as, e.g., the FAA, or the like), a travel agency, a hotel provider, a rental car provider, a taxi service provider, a limousine service provider, a shuttle service provider, a tour-guide provider, a commercial airline tracking service provider, or the like, without limitation.

The databases 160 may include, for example, any combination of software and/or hardware, including at least one application and/or at least one computer. The databases 160 may include a structured collection of records or data organized according to a database model, such as, e.g., but not limited to at least one of a relational model, a hierarchical model, a network model or the like. The databases 160 may include a database management system application (DBMS), as is known in the art. The at least one application may include, but is not limited to, for example, an application program that can accept connections to service requests from clients by sending back responses to the clients. The databases 160 may be configured to run the at least one application, often under heavy workloads, unattended, for extended periods of time with minimal human direction. The databases 160 may include a plurality of databases, including database 162 through database 168.

Further, the databases 160 may belong to, or be associated with the flight data sources 150—in which case the databases 160 may be located at the same location(s) as the flight data sources 150 or at some remote location(s). The databases 160 may include flight related data, such as, for example, airline data, flight number, airplane type, tail identification number, departure/arrival date, departure/arrival time, departure/arrival location, weather reports, and the like. Additionally, the databases 160 may include user information, such as, for example, a user profile, name, photo, signature, address, telephone number, email address, credit card number, bank account number, message delivery preferences, historical travel data, and the like. Alternatively (or additionally), the databases 160 may be independent from the flight data sources 150, but include the flight related data.

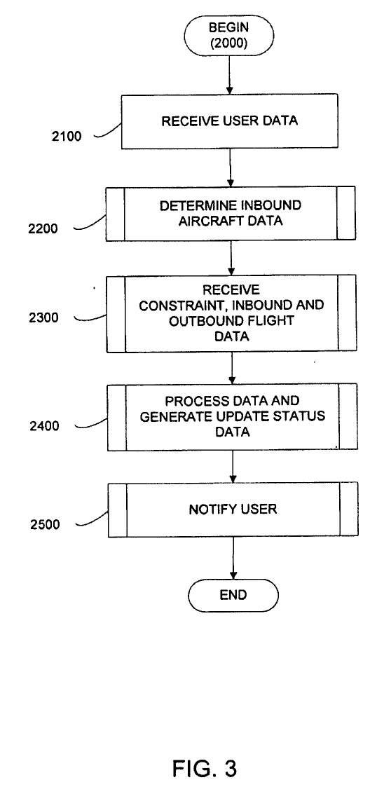

FIG. 3 shows a process 2000 for determining and updating information regarding a particular aircraft arrival and/or departure. As seen in FIG. 3, user data may be received from a UID 110 (shown in FIG. 2) (Step 2100). The user data may include, for example, but is not limited to, any one or more of the following: a unique identifier (or selection) of an airline(s); a flight number(s); an aircraft type(s); a station code(s) for the airport(s) of departure and/or arrival; a date(s) of departure and/or arrival; a time(s) of departure and/or arrival; a departure (or arrival) airport terminal number; a departure (or arrival) airport gate number; an aircraft tracking time window to be used to determine how far ahead of a target aircraft departure the user wishes the system to begin tracking candidate aircraft(s); and the like. The user data may further include, for example, a file, a record, a copy of an email itinerary in a format, such as, for example, but not limited to, Microsoft Outook™, Yahoo™, Gmail™, or the like.

The user data may be provided from the UID 110 thru, for example, a registration web page (e.g., as field-data entries, a file upload, or the like), a record, a file (such as, e.g., an itinerary, etc.), an email message, a text message, an instant message, or the like. The user data may be entered by a user using the UID 110, or a service provider, such as, for example, an airline, a travel agency, or the like, using a UID 110. The user data may be entered, for example, as a trip that includes one or more flights, ground transportation, lodging, etc. Alternatively, the user data may be parsed from a user's existing trip itinerary, which may include one or more flight connections.

Based on the received user data, inbound aircraft data may be searched, retrieved and stored, including information regarding discovered inbound aircraft that may be used by the user's outbound flight (Step 2200). The inbound aircraft data may include, for example, an aircraft type, an aircraft model, airline identification, a tail number, current altitude, current speed, current direction, current location (including GPS coordinates), flight schedule, assigned airport gate number, ship number, and the like. Constraint data may be determined (or provided) and stored as factors that affect the inbound and outbound fight performance. The constraint data may include, for example, substantially real-time data received from the flight data sources 150 (shown in FIG. 2), including, for example, but not limited to: aircraft sensors (aircraft sensor data, such as, e.g., air speed, wind speed, ground speed, current direction, ETA, GPS location, and the like); airport sensors (airport sensor data, such as, e.g., wind speed, wind direction, barometric pressure, probability of precipitation, type of precipitation, or the like); airport status monitoring systems (airport status data, such as, e.g., airport closure times, estimated or historic airport or airline times to process an arriving airplane before its ready to depart again, reported taxi times, times added by an airline because of expected delays, baseline city-pair flight times, historic weather effects on airport arrival or departure capacity, historic weather effects on city-pair flight times, airport congestion, ATC flow restrictions, or the like); and the like. Additionally, the constraint data may include, for example, data provided by an observer, an expert, an airline, a government agency, or the like, without limitation. The data may be entered using UID 110 (shown in FIG. 2). The inbound and outbound flight data is substantially real-time data received from the flight data sources 150 (shown in FIG. 2), including, for example, but not limited to: flight numbers, departure and arrival airports, scheduled, estimated, and actual departure and arrival times, departure and arrival gates and terminals, aircraft equipment types, ship numbers and current flight status. (Step 2300).

The received user data, the inbound and outbound aircraft data and the constraint data may be processed using mathematical and decision tree methodologies to generate travel update status data and a notification message that may be sent to the user (Step 2400). The notification message may be sent to the UID 110 from which the user data was received (or some other UID 110) (Step 2500).

A computer readable medium (not shown) may be provided that includes a computer program, which when executed by a general purpose computer, may cause each of Steps 2100 to 2500 to be carried out. The computer readable medium may include an instruction (e.g., code section or code segment) corresponding to each of the Steps 2100 to 2500.

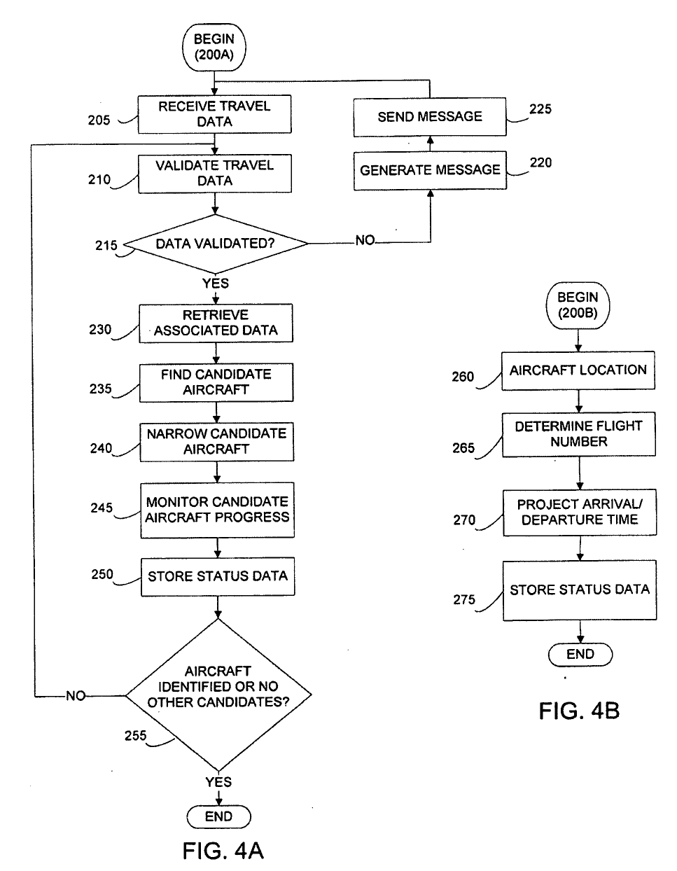

FIG. 4A shows a process 200A for determining inbound aircraft data, which may be used in Step 2200 in FIG. 3, according to an embodiment of the invention. As seen in FIG. 4A, the user data received from the UID 110 (shown in FIG. 2) may be, for example, parsed to determine user travel data (Step 205). The user travel data may include, for example, a unique airline identifier, a flight number, an airport of departure, an airport of arrival, a date of departure, a date of arrival, and the like. The user travel data may then be validated by searching associated flight data and additional flight data stored from flight data sources 150 (shown in FIG. 2) and/or databases 160 (shown in FIG. 2) (Step 210).

For example, in searching associated flight data (Step 210), airline web site(s) and/or other flight data sources 150 (FIG. 2) may be accessed to determine the type of aircraft that is operating the user's selected flight, the departure airport gate number that the user's flight will depart from; the airline's schedule of arrivals and/or departures at that same airport; gate assignment data for inbound/outbound flights that match the aircraft that is operating the user's selected flight; inbound/outbound flight numbers; and the like.

Exceptions may exist. Several aircraft can at times be assigned to the same gate at the same time. Particularly with smaller regional jets now being utilized for many flights, multiple aircraft can be assigned to the same airport gate for a given airline. This is particularly true in larger airports where several regional jets might park around the same gate area and generally at about the same time. In order to more accurately determine which inbound aircraft matches which outbound aircraft in this situation, a history of flight performance for flights that utilize a common gate at a common time may be maintained and referenced. Specifically, instances where a given inbound flight's late arrivals over time match an outbound flight's delayed departures may be analyzed. If a pattern is consistent over several instances, then this may indicate that the same aircraft is in use for the inbound and outbound flights. Whenever airlines change overall schedules, the matches of inbound to outbound flight performance may be reassessed to determine if aircraft tracking and status updating is still accurate.

If it is determined that user travel data validation failed (“NO” at Step 215), then a message may be generated (Step 220) and sent to the originating UID 110 (shown in FIG. 2) (Step 225). The notification message may include, for example, an SMS text message, an email message, a file, a record, a sound message, an instant message, or the like. Further (or corrected) user data may then be received and parsed to determine user travel data (Step 205).

If it is determined that user travel data validation was successful (“YES” at Step 215), then the flight related data associated with the user travel data may be retrieved from the flight data sources 150 and/or databases 160 (Step 230). The retrieved flight related data may include, for example, data on flights from the same airline identified in the user travel data, which are scheduled to arrive at the user's departure airport on the departure date. The retrieved flight related data may be analyzed to determine and identify one or more candidate flights that may supply the particular airplane for the user's departing flight (Step 235).

For example, based on a selection of flights, gate assignment data may be searched to determine which inbound flight matches the airline, aircraft type and gate assignment of the user's chosen outbound flight. If the airline, aircraft type and gate assignment match and if that flight is scheduled to arrive within the specified time period (such as, for example, 30 to 90 minutes, or some other predetermined time) ahead of the user's flight departure, then that same aircraft may likely be used for the inbound and outbound flights.

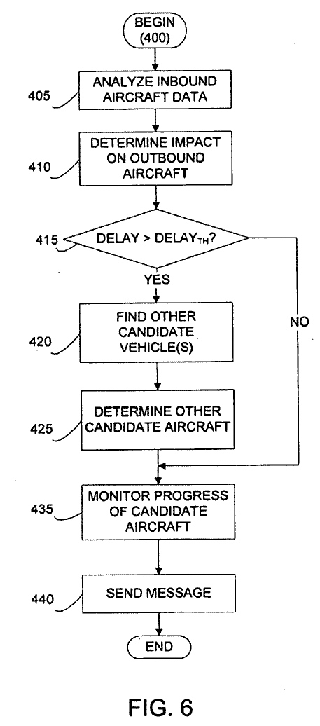

The identified candidate flight(s) may be analyzed and narrowed based on, for example, aircraft type, a variable window of time for the flight's scheduled arrival, tail number, assigned airport gate number, ship number, or the like (Step 240). The narrowed candidate flight(s) may then be monitored to determine the aircraft's progress (Step 245). For example, the narrowed candidate flight(s) may be monitored by tracking and analyzing flights of the same aircraft's planned routing on preceding segments. Status data, such as, for example, the aircraft type, the variable window of time for the flight's scheduled arrival, tail number, assigned airport gate number, ship number, or the like, may be stored (Step 250). This data may then be forwarded (or provided) to a process 400 for processing and generating update status data, according to the embodiment of the invention shown in FIG. 6.

Messages, including the status data, may be sent to the user at intervals or as otherwise requested and with the type of delivery requested by the user (Step 250). These messages may inform the user as to the current location of their aircraft, whether it is running ahead or behind schedule, and any schedule impact that might be expected as it flies the flights and traverses the cities along its route. The messages may include a summary of the information that the user's airline is providing as to their projections as to whether the flight will be on time, ahead of schedule, or delayed.

Thus, by using this approach an inbound flight that uses the same aircraft that will be used for a user's outbound flight may be determined. The same method may be used to determine additional aircraft routing information. By looking at the inbound flight number and the airline schedule, the airport the inbound flight is coming from and the departure gate assigned to that flight at that airport may be determined. Based on, for example, the airline information, the outbound flight number, its scheduled time of departure, its departure gate and the aircraft type, the inbound aircraft that will be used to fly a particular outbound flight may be determined using the invention.

By repeating Step 210 through Step 255, a particular aircraft's planned routing through several airports may be determined. As a result, the location of aircraft that will transport the user for the particular chosen flight may be determined at least one stop ahead and many times several stops ahead of the user's chosen flight.

A determination may be made whether a departure aircraft has been identified from the candidate aircraft, which is to be used as the transporting aircraft for the user (Step 255). If it is determined that a departure aircraft has not been identified (“NO” at Step 255), then the user travel data may be validated by searching further associated flight data from flight data sources 150 (shown in FIG. 2) and/or databases 160 (shown in FIG. 2) to determine further candidate aircraft (Step 210), otherwise a determination is made that a aircraft has been identified or there are no more candidate aircraft (“YES” at Step 255).

The particular airports that each particular aircraft will traverse and which flights it will fly as it moves through its scheduled routing may be determined and monitored. Each aircraft's location may be determined at the time tracking is to begin for a user.

A computer readable medium (not shown) may be provided that includes a computer program, which when executed by a general purpose computer, may cause each of Steps 205 to 255 to be carried out. The computer readable medium may include an instruction (e.g., code section or code segment) corresponding to each of the Steps 205 to 255.

FIG. 4B shows an example of a process 200B for projecting flight arrival/departure times using aircraft routings and constraint data in the process shown in FIG. 3. The current location of each candidate aircraft may be determined (Step 260). The determination may be made at predetermined times set by the user or on request by the user. The flight number being flown by the aircraft may be determined in real-time (Step 265). This may be accomplished, for example, by going to the airline web site or to a data consolidator's site and requesting real-time (or current) status of that flight. Based on an aggregate of current location data over a period of time, the aircraft's projected departure/arrival time vs. its scheduled departure/arrival time for that flight may be determined (Step 270). The projected departure/arrival time, as well as the time delay or time ahead of the scheduled departure/arrival time, may be stored to be used in analysis of the users departure time (Step 275). Further, using schedule pad time data and turn in time data saved in the Table of Constraints, projected departure/arrival time data may be used in the update status data for the airline for each segment flown and for each airport traversed by that aircraft. The projected departure/arrival data may be included in the update status data send to the user until the aircraft reaches the user's point of departure.

Further, in Step 275, for each airport that the aircraft will traverse the additional delay time or time that might be made up due to but not limited to, for example, four airport constraint factors (i.e., weather delay, ATC flow control delay, taxi delay, or hours of operation) may be added or subtracted to project the departure/arrival time of the aircraft for each segment of its flight. The resulting projected arrival and departure time at the user's airport may be determined by analyzing these factors. This data may then be forwarded (or provided) to a process 400 for processing and generating update status data, according to the embodiment of the invention shown in FIG. 6.

A computer readable medium (not shown) may be provided that includes a computer program, which when executed by a general purpose computer, may cause each of Steps 260 to 275 to be carried out. The computer readable medium may include an instruction (e.g., code section or code segment) corresponding to each of the Steps 260 to 275.

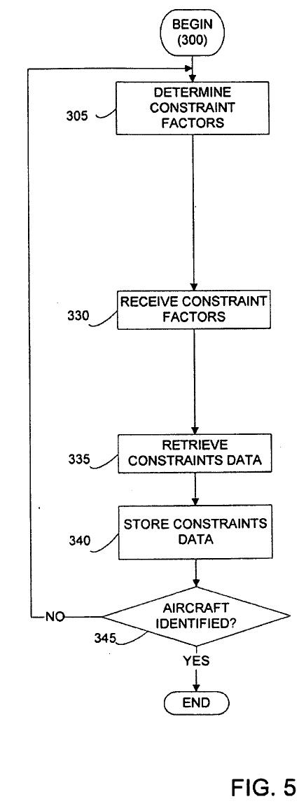

FIG. 5 shows a process 300 for determining constraint status data, which may be used in the process 2000 shown in FIG. 3, according to an embodiment of the invention. Initially, a determination is made whether constraint factors have been stored or provided for the user data (user data such as, e.g., the airline, the flight number, the tail number, the aircraft type, the departure/arrival airport, the departure/arrival time, the departure/arrival date, or the like) (Step 2100, FIG. 3) and/or the determined inbound aircraft data (Step 2200, FIG. 3) (Step 305). If it is determined that constraint factors have been stored or provided (“YES” at Step 310), then constraint factors are received and loaded (Step 330).

The constraint factors may include, for example, but are not limited to any one or more of the following: airport closure times: historic airport or airline times to process an arriving airplane before its ready to depart again; reported taxi times; times added by an airline because of expected delays; baseline city-pair flight times; historic weather effects on airport arrival or departure capacity; historic weather effects on city-pair flight times; airport congestion; ATC flow restrictions; and the like. A constraint table may be automatically or manually populated with constraints data associated with the constraint factors.

For example, additional factors that may impact flight performance may be determined and stored in order to accurately determine which aircraft will be utilized for a user's chosen flight to at least one airport prior to the user's airport of departure. Further, these factors may include, for example: analysis of possible additional delays or opportunities to make up time as the aircraft flies from city to city along its route; tracking weather data, Air Traffic Control (ATC) data, congestion on the ground at airports, government flow capacity restrictions, flight delay and arrival/departure from airline websites, airline scheduled flight times vs. actual flight times; assessing data concerning conditions at the major airports, including data available from public, airline and government sources as well as data consolidation services; and the like.

As noted earlier, the constraint factors may be provided in a Table of Constraints that may be located, for example, at the information provider 140 (shown in FIG. 2) or at some other location. As constraint data is gathered from the flight data sources 150 and/or databases 160 or entered manually for example, via UID 110 (FIG. 2), the data may be populated (or stored) into the Table of Constraints. The Table of Constraints can store timing information collected regarding both airline and/or airport impacts to an aircraft's performance against its schedule.

The Table of Constraints may be populated with constraint data using, for example, three letter station codes and time limits set for a predetermined period during which the constraints data is expected to be accurate and up-to-date. The Table of Constraints may include four or more types of data, including but not limited to: Weather delay data; ATC flow control data; actual airport taxi delay; and airport hours of operation. Airline specific data may also be entered into the Table of Constraints. This data may be used in analysis to determine the impact on the users departure flight.

Weather delay data may include, for example, historical data and real-time data regarding weather conditions at a particular airport(s). The weather delay data may be used to forecast an amount of delay time particular weather conditions may cause to flights going through a particular airport. The Table of Constraints may include, for example, the expected time delay to add to flights going through that airport and the date and time limits with which that time delay is expected to occur. Personal experience may also be used in forecasting delay time and the time intervals during which that delay will occur based on certain weather conditions. The forecasted delay time may be entered, for example, via the UID 110 (FIG. 2).

ATC flow control data may include, for example, FAA reports regarding ATC delay information on delays related to aircraft traffic flows into each airport. The amount of delay time that these ATC delays may cause to flights going through a particular airport may be forecast from the ATC flow control data. The Table of Constraints may include the expected minutes of delay to be added to flights going through that airport and the date and time limits within which that delay time is expected to occur. Personal experience may also be used to predict the minutes of delay and the time intervals during which that delay will occur.

Actual airport taxi delay data may include, for example, flight movement messages that are generated as aircraft move through the day. The messages may include, for example, Out messages, Off messages, On messages, and/or In messages. In general Out messages include messages when an aircraft leaves the gate; Off messages include messages when the aircraft takes off, including the take off time; On messages include messages when the aircraft lands, including the landing time; and In messages include messages when the aircraft arrives at the gate. These movement messages are available from the flight data sources 150 (shown in FIG. 2), such as, e.g., data consolidation services or government sources.

Taxi out time may be determined by comparing Out message times to Off message times. Taxi in time may be determined by comparing On message times to In message times. A baseline of average taxi times may be established at many of the airports by recording those times for a collection of different flights by different airlines across the hours of operation of a particular airport each day. These baselines may be stored, for example, in the information provider 140 (shown in FIG. 2). As part of monitoring each day, the actual taxi delays occurring at the airports may be monitored and tracked by time of day against baseline taxi delay times during those same times of day. When actual taxi delays differ from the baselines, a time in minutes may be stored in the Table of Constraints for each given airport. This information may be used to calculate impacts on scheduled flights going through each airport.

Airport hours of operation data may include, for example, airport operations restrictions for certain airports, such as, e.g., predetermined times of the day. The time periods of the restrictions may be automatically (or manually) entered into the Table of Constraints.

As noted earlier, the Table of Constraints may also include airline specific data, such as, e.g., but not limited to, turn time and schedule pad time. The airline specific data may be used to determine when a flight is running behind schedule. The turn time data includes a minimum amount of time required by a particular airline to service an aircraft of a given type at a gate. The service may include, e.g., disembarking passengers, cleaning the aircraft interior, performing any normal pre-flight checks and maintenance, and then loading passengers for the next flight for that aircraft. These minimum times may vary from airline to airline and within an airline by the type of aircraft. Generally, if an aircraft is running behind schedule, the airline may attempt to make up time by turning the aircraft as quickly as it can within the constraints of its standard practices. These minimum turn times may be entered into the Table of Constraints by airport, airline and/or aircraft type.

Schedule pad time data may include, for example, a difference between the actual flight operation and the scheduled travel time. At times airlines can actually operate flights in less time than that published in their schedule. The difference in time is the schedule pad time. Scheduled pad time data values may be entered in the Table of Constraints as time in minutes that an airline can makeup during a flight if it is running behind schedule. These numbers may differ by airline, aircraft type and by the length in time of the flight.

Referring to FIG. 5, constraint factors may be stored or provided by, for example, a system administrator, an observer, an expert, an airline, a travel agent, or the like that wishes to enter constraint factors. Constraint factors may be received and associated with, for example, the user data and/or the determined inbound aircraft data or the departure aircraft, which is to be used as the transporting aircraft for the user (Step 330). For example, the user may choose how far ahead of the user's flight departure time the user wants to begin tracking an aircraft.

After the constraint factors are received (Step 330), constraint data associated with the constraint factors may be retrieved (Step 335) from, for example, the information provider 140, the flight data sources 150 and/or the databases 160 and stored (Step 340). The retrieved constraint data may then be forwarded (or provided) to a process 400 for processing the user data, inbound aircraft data, outbound aircraft data and the constraint data and generating update status data, according to the embodiment of the invention shown in FIG. 6. The determination may be made whether a departure aircraft has been identified from the candidate aircraft, which is to be used as the transporting aircraft for the user (Step 345). If it is determined that departure aircraft has not been identified (“NO” at Step 345), then the process returns to determine further constraint factors for additional candidate aircrafts or if there are no other candidate aircraft the process ends (“YES” at Step 345).

A computer readable medium (not shown) may be provided that includes a computer program, which when executed by a general purpose computer, may cause each of Steps 305 to 345 to be carried out. The computer readable medium may include an instruction (e.g., code section or code segment) corresponding to each of the Steps 305 to 345.

FIG. 6 shows a process 400 for processing the received user data, the determined inbound aircraft data, the outbound aircraft data and the constraint status data to generate travel update status data and user notification data in the process 2000 shown in FIG. 3, according to an embodiment of the invention. Using the inbound aircraft(s) data (from Step 2200 in FIG. 3), and the constraint factors and constraints data (from Step 2300 in FIG. 3), the inbound aircraft(s) data is analyzed (Step 405). An impact on the user's flight departure may be determined by applying the constraint factors and constraints data to the inbound aircraft(s) data, using, for example, mathematical and decision tree analytic methodologies. The determined impact on the user's flight departure may include, for example, an advance (or predicted advance) in flight time, a delay (or predicted delay), a cancellation (or predicted cancelation), or the like (Step 410).

A determination may be made whether the impact includes a delay greater than a predetermined threshold DELAYTH (Step 415). The predetermined threshold DELAYTH may include, for example, a cancellation, a denied boarding, or a delay time which would render the candidate aircraft(s) unlikely (or unable) to depart at, or before the user's scheduled departure time. If it is determined that the impact does not include a delay greater than the predetermined threshold DELAYTH (“NO” at Step 415), then the progress of previously determined candidate aircraft(s) is monitored (Step 435). A message may be generated and sent to the UID 110 from which the user data was received (shown in FIG. 2), or another UID 110 (Step 440), where the sent message may include status data regarding the progress of each candidate aircraft, including the travel update status data.

However, if it is determined that the impact includes a delay greater than the predetermined threshold DELAYTH (“YES” at Step 415), then a further search may be conducted for other flights on the same or other airlines that may provide the user alternative departure options (Step 420). Based on the results of the search (Step 420), other candidate aircraft(s) may be determined (Step 425). The progress of each candidate aircraft may be monitored (Step 435) and a message may be generated and sent to the UID 110 from which the user data was received (shown in FIG. 2), or another UID 110 (Step 440). The sent message may include additional notifications (such as, e.g., to continue monitoring and analyzing the status of the departure flight), in addition to the travel update status data for the progress of each candidate aircraft.

The travel update status data may include, for example, but is not limited to, airline identification, aircraft type, aircraft model, tail number, current/average air speed, current/average wind speed, current (or average) ground speed, current (or average) aircraft flight (or taxing) direction, current (or average) estimated-time-of-arrival (ETA), current GPS location, current (or projected) flight schedule, current (or planned) departure (or arrival) airport(s), current (or planned) departure (or arrival) terminal number, current (or planned) departure (or arrival) gate number, current (or planned) departure (or arrival) time(s) and date(s), and the like, the status of the inbound aircraft (on-time, delayed or at the gate), and the amount of calculated or predicted delay, the status of the outbound flight status (on-time or delayed) and the calculated or predicted delay amount. The travel update status data may further include relationship status information for each of a plurality of connection flight segments, where more than one candidate aircraft is involved in transporting the user from the departure location to the destination location. The Connecting flight information may include flight status (on-time or delayed, the calculated or predicted delay and the connecting time between flights.

A computer readable medium (not shown) may be provided that includes a computer program, which when executed by a general purpose computer, may cause each of Steps 405 to 440 to be carried out. The computer readable medium may include an instruction (e.g., code section or code segment) corresponding to each of the Steps 405 to 440.

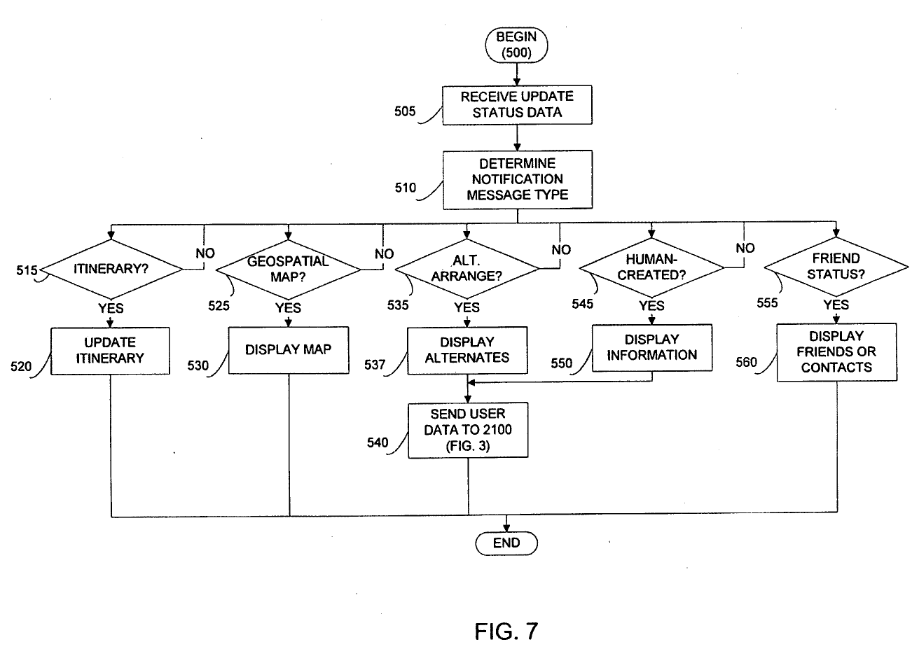

FIG. 7 shows a process 500 for sending messages and user notification data to a user in the process 2000 shown in FIG. 3, according to an embodiment of the invention. As seen in FIG. 7, the travel update status data may be received for each candidate aircraft (from Step 2400 in FIG. 3) (Step 505). Based on the received travel update status data, a determination may be made regarding the type of notification message to be communicated to the UID 110 (Step 510). The notification message may include, for example, a record, a record field entry, a file, an email message, a text message, an SMS text message, a sound message, a broadcast message, an instant message, or the like. The notification message may further include the travel update status data.

Depending on the determined type of notification message, a determination may be made whether to: automatically (or under user instruction) update (or synchronize) a travel itinerary (such as, e.g., an itinerary associated with the original user data provided from the UID 110, or the like) (Step 515); display a geospatial map (Step 525); display additional information and/or links that may assist the user (Step 535); display human-created messages into a stream of notifications to deliver to an individual user, or group of users (Step 545); or inform the user when other users that are identified friends or contacts are nearby (Step 555). It is noted that additionally types of notification messages may be determined and displayed, without departing from the scope or spirit of the invention.

If a determination is made to update the itinerary (“YES” at Step 515), then the data in the travel itinerary is updated, including, for example, but not limited to, airline, aircraft, airport, terminal number, gate number, target departure time, arrival time at desired location (or at intervening location(s)), and the like (Step 520). The travel itinerary may be provided in a computer based calendar format, such as, for example, but not limited to, Microsoft Outlook™, Yahoo™, Gmail™, or the like. In this regard, the user may have originally provided a copy of an email itinerary (file or record) as the user data.

If a determination is made to display a geospatial map (“YES” at Step 525), then a geospatial map may be displayed on the UID 110 (Step 530). The geospatial map may include, for example, up-line and target aircraft location and flight data, airport terminal data, and the like.

If a determination is made to display additional information and/or links that may assist the user (“YES” at Step 535), then additional information and/or links may be displayed to assist the user in, for example, but not limited to, booking other flights, hotels, rental cars, taxi pickup, shuttle pickup, or the like (Step 537). The additional information may include, but is not limited to, for example: an Airline Bill of Rights section that may apply to a determined disruption (such as, e.g., a canceled flight, a substantially delayed flight, denied boarding, or the like); Airline Carriage contract rules that apply to the determined disruption, such as, e.g., meal and hotel vouchers, airline dollars, and other compensations from which the user may be entitled; a form or link to send complaints to the Department of Transportation (DOT), another government agency, the airline, or the like, because of problems with airline service; local lodging, ground transportation, or alternative flights on the following day (or at some other date) where, for example, the target flight is the “last flight of day” to the desired destination and has been determined to be greatly delayed or canceled; and the like. Further, user data may be collected and sent to Step 2100 of the process 2000 in FIG. 3 and the process 2000 repeated with the new user data (Step 540).

If the additional information and/or links (“YES” at Step 535) includes the same or other airlines that cover both flights scheduled to depart before the target flight, but were delayed, and flights for some period of time after the target delayed or canceled flight, then alternate flights for the same or other airlines that cover both flights scheduled to depart before the target flight, but were delayed, and flights for some period of time after the target delayed or canceled flight may be displayed (Step 537). The user's selections may be collected as user data and sent to Step 2100 of the process 2000 in FIG. 3 and the process 2000 repeated with the new user data (Step 540).

If a determination is made to display human-created messages into a stream of notifications to deliver to an individual user, or to a group of users (“YES” at Step 545), then information relevant to their travel but not provided by automated analysis may be provided to the user(s) (Step 550). The information may include, for example, but is not limited to, an answer to a previously asked question; a result of a concierge activity; general information of importance relative to the airline being flown; general information relevant to current air travel; or information regarding other items that may have impact on the travel to which the notifications apply. Additionally, the information may include, for example, non-travel related information, such as, but not limited to, information desired by the user; weather information in cities not on the current itinerary; news or stock quotes relating to the user to which the trip relates; and/or other information relating to items that would benefit the user from consolidation within the message.

Further, the human-created messages may include alerts to warn users of factors that may affect their flight's departure and/or arrival. The alerts may include, for example, information related to airport and/or airlines, which may have been provided by an expert observer; airport code; airline; additional delay time; start and end date of a particular alert message; time period that a particular alert message may be effective; alert message text; and the like. Further, the alert message need not be human-created, but may instead be automatically generated.

If a determination is made to inform the user when other users that are identified friends or contacts are nearby (“YES” at Step 555), then information may be displayed regarding the other users (Step 560). The determination (Step 555) may be made, for example, by determining when identified friends or contacts are traveling into or out of a common airport, city, or location within a defined period of time. In this regard, location determination may be based on, for example, a GPS receiver in the UID 110 of the friend or contact, as well as the user's own UID 110; triangulation using cell stations or satellites; location relative to a particular access point, or the like. The information may include, for example, but is not limited to, any one or more of the following: a distance from the friend to the user (or some other reference point that may be selected); a picture of the friend or contact; a profile of the friend or contact; a travel itinerary of the friend or contact; or the like. The friend or contact may be displayed on a geospatial map on the UID 110 (Step 560). The geospatial map may include, for example, up-line and target aircraft location and flight data, airport terminal data, and the like, as well as the friend or contact location, and the like.

A particular user may be associated as a friend or contact by, for example, importing a contact (or contact list) from, but not limited to, Microsoft Outlook™, Yahoo™, Gmail™, Linkedin™, Facebook™, myspace™, or the like. A particular user may also be associated as a friend or contact in different groups that may be determined when location notification is provided. The user may be able determine by trip and/or friend (or contact) whether the user's presence will be visible to other users.

A computer readable medium (not shown) may be provided that includes a computer program, which when executed by a general purpose computer, may cause each of Steps 505 to 560 to be carried out. The computer readable medium may include an instruction (e.g., code section or code segment) corresponding to each of the Steps 505 to 560.

Although the invention has been described with reference to several embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

For example, the invention may be used for tracking, for example, without limitation, packages, ships, taxis, buses, truck, trains, limousines, shuttles, or the like.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Accordingly, replacement standards and protocols having the same functions are considered equivalents.

What is claimed is:

1. A method for providing early and accurate information relating to a status of a particular flight, the method comprising:
receiving user data that includes aircraft departure information;
determining inbound aircraft and outbound aircraft data based on the user data;
receiving constraint status information; and
generating update status data based on the inbound aircraft data, outbound aircraft data and constraint status information.

2. The method according to claim 1, further comprising:
generating an update status message based on the update status data and user data.

3. The method according to claim 1, further comprising: sending an update status message to a user.

4. The method according to claim 1, wherein the determining inbound aircraft data comprises:
parsing travel data from the user data;
validating the travel data to determine validated data; and
determining a candidate aircraft based on the validated data.

5. The method according to claim 4, wherein the determining inbound aircraft data further comprises:
monitoring progress of the candidate aircraft, including aircraft location data;
identifying a target aircraft to be used for a predetermined flight; and
sending an update status message to a user.

6. The method according to claim 5, wherein the update status message comprises:
a geospatial map comprising the aircraft location data;
an itinerary update message;
an alternative arrangement message;
a human created message; or
a friend status message.

7. The method according to claim 5, wherein the determining inbound aircraft data further comprises:
determining travel date and departure airport from the travel date;
searching within available flight data to find the candidate aircraft; and
determining the target aircraft based on candidate aircraft data.

8. The method according to claim 7, wherein the candidate aircraft data comprises:
an airline identification;
an airline name;
aircraft type;
a variable window of time for the candidate aircraft scheduled arrival;
a tail number;
an assigned airport gate number; or
a ship number.

9. The method according to claim 1, wherein the constraint status information comprises constraint status factors and a constraint status data.

10. The method according to claim 9, wherein the constraint status factor comprises:
weather delay data;
ATC flow control data;
airport, airline turn times;
airport taxi delay data; or
airport hours of operation data.

11. A computer readable medium comprising a computer program, the medium comprising:
a user data receiving section, which when executed on a computer causes receiving user that includes aircraft departure information;
an inbound aircraft determining section, which when executed on a computer causes determining inbound aircraft data based on the user and external source data;
a constraint status information receiving section, which when executed on a computer causes receiving constraint status information; and
an update status generating section, which when executed on a computer causes generating update status data based on the inbound aircraft data, outbound aircraft data, and constraint status information.

12. The medium according to claim 11, further comprising:
an update status message generating section, which when executed on a computer causes generating an update status message based on the update status data and users departure flight data.

13. The medium according to claim 11, further comprising:
an update status message sending section, which when executed on a computer causes sending an update status message to a user.

14. The medium according to claim 11, further comprising:
a travel data parsing section, which when executed on a computer causes section parsing travel data from the user data;
a travel data validating section, which when executed on a computer causes validating the travel data to determine validated data; and
a candidate aircraft determining section, which when executed on a computer causes determining a candidate aircraft based on the validated data.

15. The medium according to claim 14, further comprising:
a progress monitoring section, which when executed on a computer causes monitoring progress of the candidate aircraft, including aircraft location data;
a target aircraft identifying section, which when executed on a computer causes identifying a target aircraft to be used for a predetermined flight; and
an update status message sending section, which when executed on a computer causes sending an update status message to a user.

16. The medium according to claim 15, wherein the update status message comprises:
a geospatial map comprising the aircraft location data;
an itinerary update message;
an alternative arrangement message;
a human created message; or
a friend status message.

17. The medium according to claim 15, further comprising:
a travel data determining section, which when executed on a computer causes determining travel date and departure airport from the travel date;
a flight data searching section, which when executed on a computer causes searching within available flight data to find the candidate aircraft; and
a target aircraft determining section, which when executed on a computer causes determining the target aircraft based on candidate aircraft data.

18. The medium according to claim 17, wherein the candidate aircraft data comprises:
an airline identification;
an airline name;
aircraft type;
a variable window of time for the candidate aircraft scheduled arrival;
a tail number;
an assigned airport gate number; or
a ship number.

19. The medium according to claim 11, wherein the constraint status information comprises at least one of a constraint status factor and a constraint status data.

20. The medium according to claim 19, wherein the constraint status factor comprises:
weather delay data;
ATC flow control data;
airport, airline turn times;
airport taxi delay data; or
airport hours of operation data.
